(19) United States
(12) Patent Application Publication
(10) Pub. No.: US 2026/0311654 A1
(43) Pub. Date: Oct. 8, 2026

(54) Method of handling backlight of display panel and related image processing circuit and display system

(71) Applicant: NOVATEK Microelectronics Corp., Hsin-Chu (TW)

(72) Inventors: Jing-Teng Lin, Tainan City (TW); Shih-Chieh Hsu, Tainan City (TW); Shu-Wei Chang, Tainan City (TW)

(73) Assignee: NOVATEK Microelectronics Corp., Hsin-Chu (TW)

(21) Appl. No.: 19/172,581

(22) Filed: Apr. 7, 2025

(51) Int. Cl. G09G 3/34

(52) U.S. Cl. CPC G09G 3/3426; G09G 2320/0233; G09G 2320/045; G09G 2320/0646; G09G 2340/0435; G09G 2360/16

(57) ABSTRACT

A method of handling a backlight of a display panel includes steps of: receiving a first part of a first frame of image data; receiving a second part of the first frame of image data; and calculating a first backlight data corresponding to the first part of the first frame of image data when receiving the second part of the first frame of image data.

### BACKGROUND OF THE INVENTION

### 1. Field of the Invention

The present invention relates to a method of handling backlight of a display panel, and more particularly, to a method of local dimming for controlling the backlight of a display panel and related image processing circuit and display system.

### 2. Description of the Prior Art

Nowadays, local dimming technology is commonly used in a display device, especially a vehicle display device. In the local dimming control, the backlight intensity on a panel is adjusted in partition to be adapted to the image content. Therefore, the backlight may be turned on only at positions having images, thereby improving the contrast of the display images.

In a vehicle display, the improvement of contrast helps reduce the eye fatigue of the driver when driving at night. The local dimming processing in the vehicle display has requirements of high accuracy and high speed. In the prior art, the backlight data of an image frame are calculated after obtaining the entire frame of image data, and then sent to the backlight driver in the blanking interval of display. Therefore, the backlight driver updates the data in the backlight module in the next frame period. The 1-frame delay causes that the backlight cannot be output timely, thereby reducing the accuracy of the backlight. In addition, the length of the blanking interval is usually far shorter than the length of the entire frame period; hence, with the trend of increasing panel size and resolution, the length of the blanking interval might not be enough to deliver the backlight data for the overall display panel.

### SUMMARY OF THE INVENTION

It is therefore an objective of the present invention to provide a novel method of handling the backlight of a display panel, in order to solve the abovementioned problems.

An embodiment of the present invention discloses a method of handling a backlight of a display panel. The method comprises steps of: receiving a first part of a first frame of image data; receiving a second part of the first frame of image data; and calculating a first backlight data corresponding to the first part of the first frame of image data when receiving the second part of the first frame of image data.

Another embodiment of the present invention discloses an image processing circuit to handle a backlight of a display panel. The image processing circuit receives a first part of a first frame of image data and receives a second part of the first frame of image data. The image processing circuit comprises a backlight data calculation circuit, which calculates a first backlight data corresponding to the first part of the first frame of image data when the image processing circuit is receiving the second part of the first frame of image data.

Another embodiment of the present invention discloses a display system, which comprises a display panel, a display driver, a backlight driver and an image processing circuit. The display driver is coupled to the display panel. The backlight driver is coupled to a backlight module of the display panel. The image processing circuit is coupled to the display driver and the backlight driver, to handle a backlight of the display panel. The image processing circuit receives a first part of a first frame of image data and receives a second part of the first frame of image data. The image processing circuit comprises a backlight data calculation circuit, which calculates a first backlight data corresponding to the first part of the first frame of image data when the image processing circuit is receiving the second part of the first frame

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a display system according to an embodiment of the present invention.

FIG. 2 is a schematic diagram of a local dimming controller according to an embodiment of the present invention.

FIG. 3 is a timing diagram of backlight calculation and image data compensation performed by a general local dimming controller.

FIG. 4 is a timing diagram of backlight calculation and image data compensation performed with delayed image data output.

FIG. 5A and FIG. 5B illustrate the comparison of output backlight between a conventional local dimming method and the pipelined and parallel local dimming method of the present invention under dynamically changing images in a series of image frames.

FIG. 6 is a timing diagram of backlight calculation and image data compensation performed by a local dimming controller according to an embodiment of the present invention.

FIG. 7 illustrates an image frame with partitions based on the backlight module.

FIG. 8 is a timing diagram of calculating and outputting backlight data row by row.

FIG. 9 is a timing diagram of calculating and outputting backlight data where the image data are divided into 2 parts.

FIG. 10A illustrates a frame of image to be sent to the dashboard of a car with multiple grids representing an array of backlight units.

FIG. 10B illustrates a detailed implementation of the pipelined backlight processing for the image frame shown in FIG. 10A.

FIG. 11 illustrates a detailed implementation of performing backlight calculation based on predicted image data.

FIG. 12 is a flowchart of an image processing process according to an embodiment of the present invention.

### DETAILED DESCRIPTION

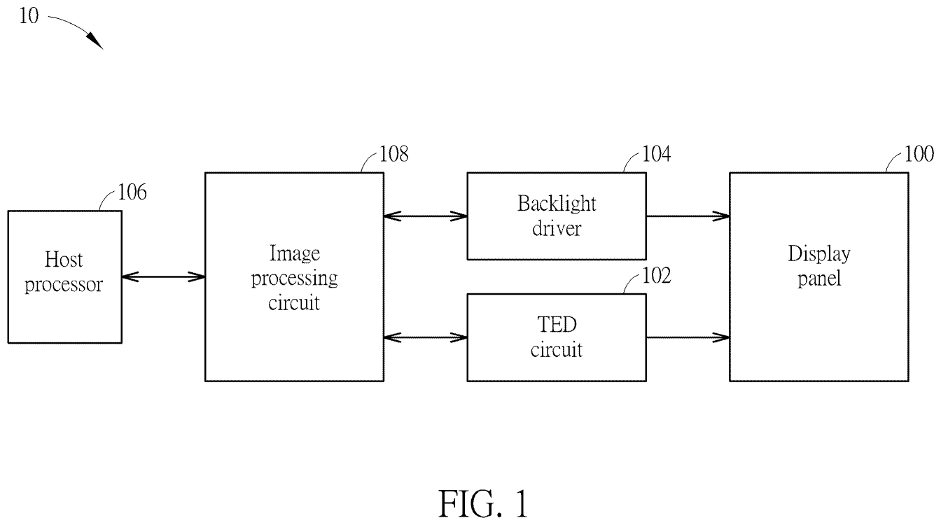

FIG. 1 is a schematic diagram of a display system 10 according to an embodiment of the present invention. The display system 10 includes a display panel 100, a TED circuit 102, a backlight driver 104, a host processor 106 and an image processing circuit 108. Since the display system 10 has the local dimming function for backlight control, the display panel 100 may be a liquid crystal display (LCD) panel or any other non-self-luminous panel. More specifically, the display panel 100 may include a backlight module to generate backlight emissions for the display operations. In various embodiments, the backlight module includes a light-emitting diode (LED) array spread below the pixels of the display panel 100. The LED array is implemented as a light source to emit light when the display panel 100 shows images.

The TED circuit 102, which is coupled between the display panel 100 and the image processing circuit 108, refers to a timing controller (TCON) with embedded source driver. The source driver, as a display driver, is responsible for outputting data voltages to the data lines on the display panel 100 according to the image data received from the image processing circuit 108. The TCON is responsible for generating control signals for the display panel 100, and outputting the control signals to the display panel 100 to control the pixels on the display panel 100 to receive the corresponding data voltages. In this embodiment, the TCON and the source driver are integrated in the TED circuit 102, which may be implemented as an integrated circuit (IC) included in a chip. In another embodiment, the TCON and the source driver may be implemented in two separate chips, and/or the source driver may include multiple chips. Alternatively or additionally, the TCON and/or the source driver may be integrated with the image processing circuit 108.

The backlight driver 104, which is coupled between the display panel 100 and the image processing circuit 108, is configured to drive the backlight module of the display panel 100 according to the backlight data received from the image processing circuit 108. As mentioned above, the backlight module may be implemented with an LED array, and thus the backlight driver 104 may be an LED driver, which is capable of outputting currents to drive the LEDs in the backlight module to emit light. In various embodiments, the backlight data may indicate a duty cycle for turning on each LED and/or a current magnitude sent to each LED in each display frame period, thereby controlling the brightness emitted by each LED.

The host processor 106 may be implemented with or connected to a video source, which provides raw image data to be sent to the image processing circuit 108 through a transmission interface. Examples of the transmission interface include, but not limited to, the low-voltage differential signaling (LVDS) or high definition multimedia interface (HDMI). In various embodiments, the host processor 106 may be a core processor of the display system 10, such as a central processing unit (CPU), a microcontroller unit (MCU), a microprocessor, or the like. As for a center information display (CID) system of a vehicle, the host processor 106 may be an automotive MCU, which provides the image data that need to be displayed on the dashboard.

The image processing circuit 108, which is coupled between the host processor 106 and the display panel 100, is configured to process the image data to be sent to the display panel 100, and correspondingly generate the backlight data. When receiving the raw image data from the host processor 106, the image processing circuit 108 may perform various image processing operations on the raw image data. For example, the received raw image data may include basic information to be shown on the car dashboard, and the image processing circuit 108 may add one or more on-screen display (OSD) icons to the display image if necessary. the image data having the basic information and the OSD icon(s) are then used to generate the backlight data. In various embodiments, the image processing circuit 108 may also apply several image processing schemes to improve the visual effects. The image processing schemes may include, but not limited to, demura, deburn-in, and subpixel rendering (SPR).

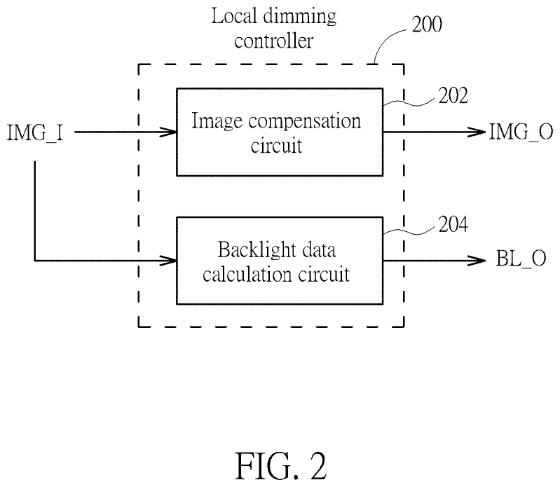

Note that the image processing circuit 108 of the present invention has the local dimming function, and thus it may generate the backlight data for local dimming control according to the image data. FIG. 2 is a schematic diagram of a local dimming controller 200 according to an embodiment of the present invention. The local dimming controller 200 may be implemented with or included in an image processing circuit of a display system, such as the image processing circuit 108 shown in FIG. 1. As shown in FIG. 2, the local dimming controller 200 includes an image compensation circuit 202 and a backlight data calculation circuit 204. The local dimming controller 200 may receive an input image data IMG_I, which may contain the raw image data provided from the host processor 106 and the added OSD images. Based on the backlight partition, the backlight data calculation circuit 204 may calculate the backlight data BL O for each area of the backlight module according to the corresponding input image data IMG_I, and then send the backlight data BL_O to the backlight driver. As mentioned above, the backlight module may include an LED array, and thus each backlight data BL_O may be used for a corresponding LED.

In general, the light emission in each area of the display panel may be mainly provided from the corresponding LED below this area, and also affected by nearby LEDs in the backlight module. Since the local dimming operation provides light emission only in the areas having images, it may influence the brightness uniformity of the images. In order to improve the brightness uniformity, the image compensation circuit 202 may compensate the input image data IMG_I according to the backlight data BL_O to generate output image data IMG_O, and then send the output image data IMG_O to the display driver, which may be a source driver included in the TED circuit 102.

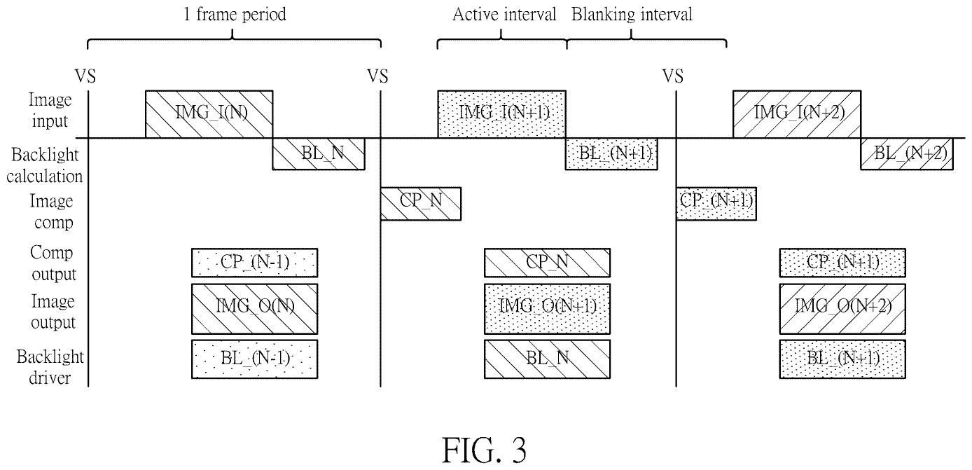

FIG. 3 is a timing diagram of backlight calculation and image data compensation performed by a general local dimming controller. The timing may be determined by using vertical synchronization signals VS, which indicate each frame period for receiving a frame of image data from the host processor and sending a frame of image data to the display driver and/or display panel. Each frame period may be divided into an active interval and a blanking interval. The active interval is a time period where the input image data (i.e., IMG_I (N), IMG_I (N+1) . . . ) are received. The blanking interval is a time period where no input image data is received.

In the first frame period, the local dimming controller receives the input image data IMG_I (N) in the active interval. After the input image data IMG_I (N) are completely received, the backlight data calculation circuit performs backlight calculation according to the input image data IMG_I (N) in the subsequent blanking interval, to generate backlight data BL_N. After the backlight data BL_N are generated, the image compensation circuit then calculates the compensation data CP_N according to the backlight data BL_N.

However, in the first frame period where the input image data IMG_I (N) are received, the local dimming controller may directly forward the corresponding output image data IMG_O (N) to the display panel. At this time, since the compensation data CP_N of this image frame have not been obtained, the compensation data used to compensate the output image data IMG_O (N) may be the previous compensation data CP_ (N−1) generated from the previous frame of backlight data. Similarly, since the backlight data BL_N of this image frame have not been obtained, the backlight data used for the output image data IMG_O (N) may be the previous backlight data BL_ (N−1) generated from the previous frame of image data. In other words, in this frame period, the control signals output by the backlight driver for displaying the output image data IMG_O(N) are based on the previous backlight data BL_ (N−1).

The local dimming controller and the related source driver and backlight driver may repeat similar operations in a series frame periods, which will not be detailed herein. As a result, the image compensation and backlight control for each frame of image data are based on the previous image frame, which may not achieve a satisfactory accuracy of local dimming.

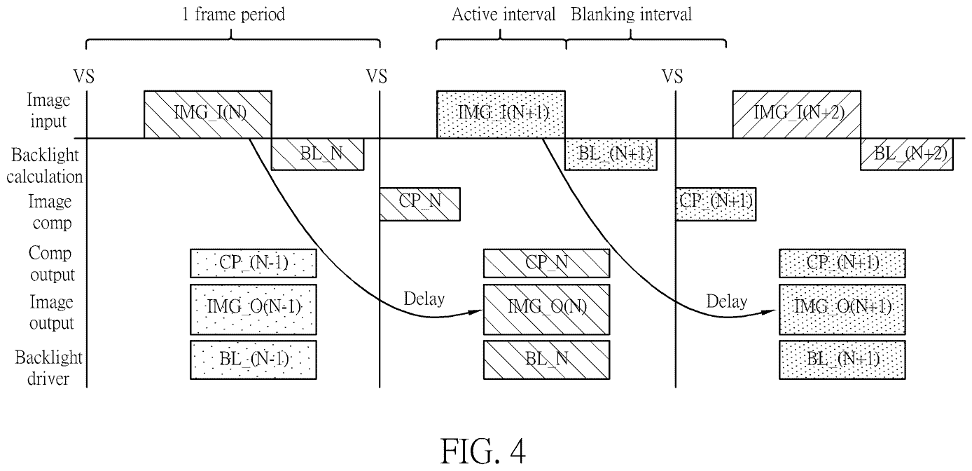

In order to solve the above problems, the output timing of the output image data IMG_O (N) may be delayed. For example, as shown in FIG. 4, the operations of backlight calculation and image compensation are similar to those in FIG. 3, but each frame of image data is output with a delay of one frame period. More specifically, each frame of input image data is received in the present frame period, and then be compensated and output in the next frame period. This may be achieved by using a frame buffer. As a result, the backlight data BL_N and the compensation data CP_N may both be used for the corresponding output image data IMG_O (N), thereby improving the accuracy of local dimming.

However, the frame buffer occupies nonignorable circuit areas and consumes more power, especially for a display panel having a large scale and/or high resolution. In addition, the frame buffer is usually implemented with a static random access memory (SRAM). In general, the SRAM has a higher probability of failure, and thus the frame buffer will increase the risk of screen freezes.

Therefore, the present invention provides a method of local dimming for controlling the backlight of a display panel, where the input image reception and backlight data processing are performed in parallel in a pipeline manner. The present invention may include two main technical features. The first feature is that the image and backlight information is processed in parallel without using any frame buffer, allowing the backlight data output to be synchronous to the image data output.

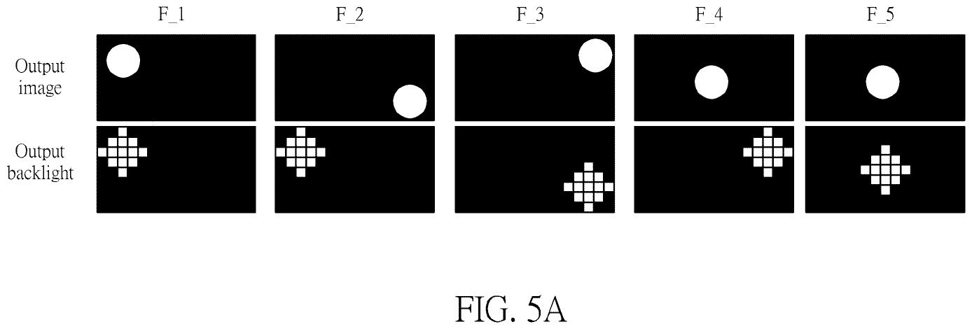

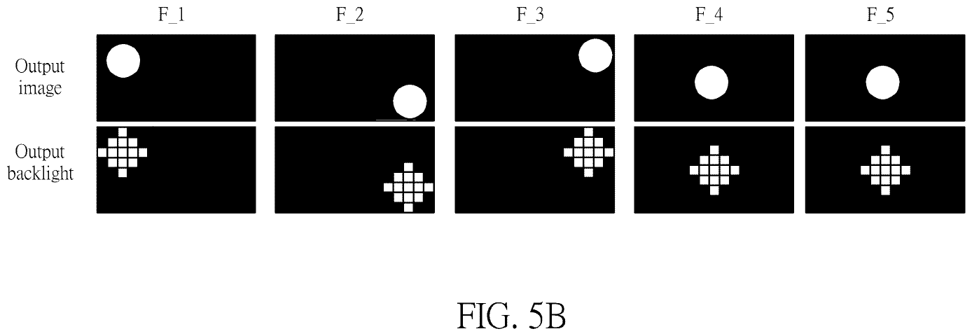

FIGS. 5A and 5B illustrate the comparison of output backlight between a conventional local dimming method and the pipelined and parallel local dimming method of the present invention under dynamically changing images in a series of image frames F_1-F_5. FIG. 5A shows the conventional case, where the backlight output follows the image output with a 1-frame delay. This backlight output may be generated based on the implementation shown in FIG. 3. When any of the image frames F_1-F_5 is output, the corresponding backlight data have not been completely calculated and obtained; hence, this image frame is output with the backlight data of the previous frame, and the backlight data will be output in the next frame period. In such a situation, the accuracy of local dimming is reduced, which reduces the image quality and also impacts the application of the vehicle display system. For example, if a warning icon needs to be shown on the car dashboard, the image may appear after a delay time, thus affecting the driving safety.

FIG. 5B shows the output backlight generated by the pipelined and parallel processing of the present invention. As shown in FIG. 5B, the image display and backlight output are synchronized; that is, the backlight data are output timely without significant delay, where the variation of backlight will rapidly follow the dynamic variation of the displayed image in each frame. According to the present invention, the timely backlight output is achieved without using any frame buffer. In such a situation, as for a vehicle display system, the actual image shown on the car dashboard will be closer to the image that the system needs to display. In addition, the compensation data may also be timely obtained and used to compensate the corresponding input image data to generate the desired output image data.

The second feature of the present invention is that the backlight data are calculated and sent in partitions. More specifically, an image frame may be divided into multiple parts, where the backlight data of different parts are calculated respectively and separately. Therefore, the backlight data of each part may be output right after this part is completely generated, and thus the backlight data of different parts may be output separately. In an exemplary embodiment, the image processing circuit (e.g., the local dimming controller 200 shown in FIG. 2) may receive a frame of image data, which includes a first part and a second part following the first part. The backlight data calculation circuit 204 may calculate the backlight data corresponding to the first part of this frame of image data when the local dimming controller 200 is receiving the second part of this frame of image data. At this time, since the image data of the first part have been completely received, the backlight data for the first part could be calculated and obtained.

In this manner, before the backlight data for the second part are calculated, the backlight data for the first part may be completely calculated and output to the backlight driver. This significantly improves the efficiency of delivering the backlight data, to make the timely backlight output and accurate local dimming control feasible.

The operations of processing backlight in partitions allow the backlight data to be sent to the backlight driver in the active interval of the frame period. Note that the length of the blanking interval is usually far shorter than the length of the active interval in a frame period, and thus the blanking interval might not be long enough to deliver the backlight data with the increasing panel size and resolution. In contrast, in the present invention, the backlight data are allowed to be sent to the backlight driver in the active interval, which has more sufficient time for the calculation and delivery of the backlight data.

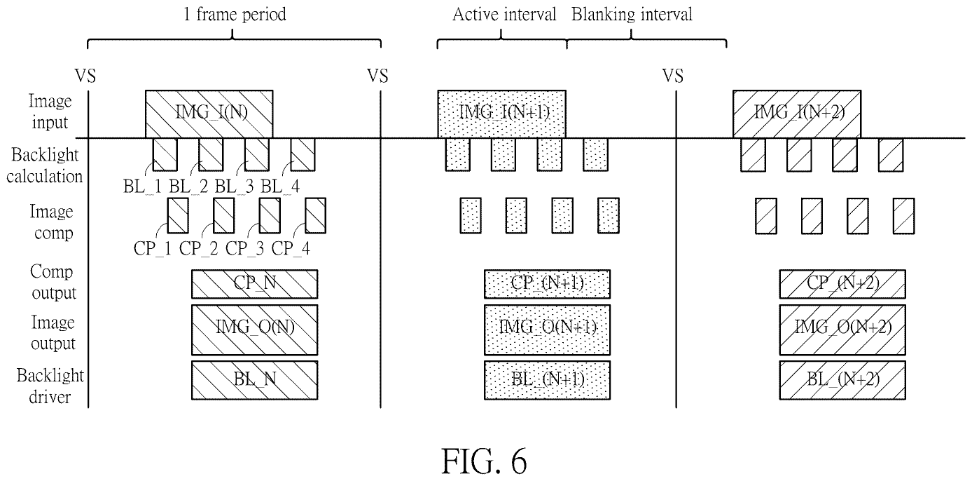

FIG. 6 is a timing diagram of backlight calculation and image data compensation performed by a local dimming controller according to an embodiment of the present invention. Similarly, the vertical synchronization signals VS may determine the frame periods, where a frame of image data is received by the local dimming controller and sent to the display driver in each frame period. The active interval and the blanking interval are allocated accordingly. In this embodiment, the image data are divided into 4 parts to calculate the backlight data. More specifically, as for each frame of input image data IMG_I (N), IMG_I (N+1) . . . , the backlight data for 4 different parts are calculated separately and obtained as BL_1-BL_4.

As a result, in the frame period of the input image data IMG_I (N), the corresponding output image data IMG_O (N) may be sent to the display driver without being delayed by one frame period. The backlight data BL_N (including the respectively calculated and obtained backlight data BL_1-BL_4) for the output image data IMG_O (N) may also be output to the backlight driver timely. In other words, the output image data IMG_O (N) and the corresponding backlight data BL_N may be output in the same frame period. In addition, as shown in FIG. 6, several or all of the backlight data BL_1-BL_4 may be calculated in the active interval where the corresponding input image data IMG_I (N) are received, and may also be output to the backlight driver in the active interval, thereby improving the efficiency of backlight data delivery.

Similarly, since the image data compensation is performed based on the backlight data, the compensation data may also be calculated in partitions. As shown in FIG. 6, the image data are divided into 4 parts to calculate the backlight data BL_1-BL_4, which are also used for calculating the compensation data CP_1-CP_4, respectively. Therefore, when the local dimming controller 200 is receiving any of the second to fourth parts of the input image data IMG_I (N), the image compensation circuit 202 may calculate the compensation data CP_1 corresponding to the first part of the input image data IMG_I (N) that have been received. The compensation data CP_1 are then used to compensate the first part of the input image data IMG_I (N), and the compensated first part of the output image data IMG_O (N) is output to the display driver in the corresponding frame period without waiting for reception and processing of other parts of the image data.

As a result, the calculation and sending of backlight data may be performed synchronously with the reception of the input image data. The compensation data may also be calculated right after the corresponding backlight data are obtained. Therefore, when the compensated output image data IMG_O (N) are sent to the display driver, the corresponding backlight data BL_1-BL_4 may be sequentially sent to the backlight driver, thereby realizing real-time image processing and output without significant delay. In this manner, the image data do not need to be written into the frame buffer, and the accuracy of local dimming control may still be achieved.

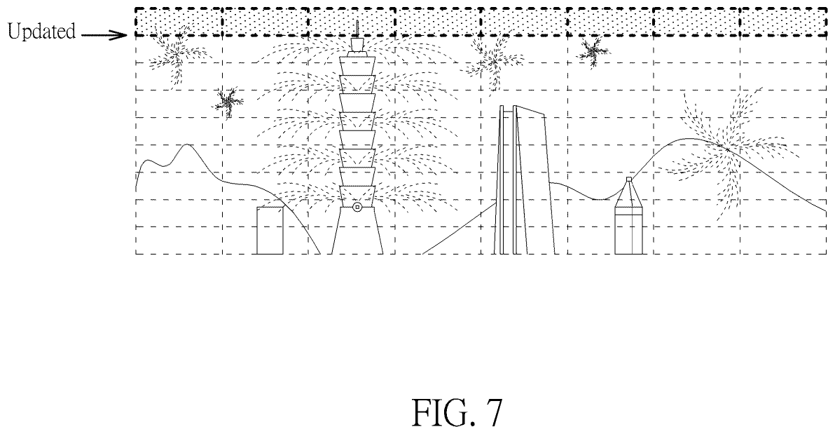

In the present invention, a frame of image data may be divided into multiple parts in various manners. For example, FIG. 7 illustrates an image frame with partitions based on the backlight module, where the backlight module includes 8 columns and 9 rows of backlight units, each represented by a grid covered on an area of the image. In one or several embodiments, each backlight unit may have an LED configured to emit light based on the corresponding backlight data. In general, the display screen is refreshed row by row from up to down, and the image data are processed by the local dimming controller in this sequence. In such a situation, the backlight data for an image frame may be calculated row by row from up to down. For example, as shown in FIG. 7, when the image data corresponding to the first row of backlight units are updated, the first row of backlight data may be completely calculated and sent to the backlight driver. In such a situation, each row of backlight units may be considered as a part to calculate the backlight data and related compensation data.

At the time when the backlight data of the first row of backlight units are calculated, the local dimming controller is still receiving the image data corresponding to subsequent rows of backlight units, so as to realize the parallel processing of backlight calculation.

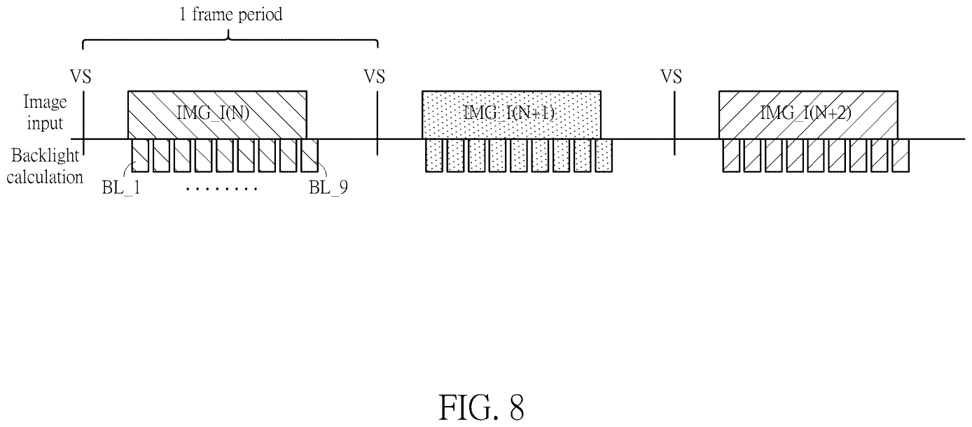

FIG. 8 is a timing diagram of calculating and outputting backlight data row by row, where the operations may be applicable to the image frame shown in FIG. 7. In detail, the image frame is divided into 9 parts, each corresponding to a row of backlight units. The backlight data calculation circuit may first calculate the first row of backlight data BL_1 and send the backlight data BL_1 to the backlight driver, then calculate the second row of backlight data BL_2 and send the backlight data BL_2 to the backlight driver, and so on, until the backlight data BL_9 are completely calculated and output.

In several embodiments, the backlight data may be adjusted and optimized according to adjacent backlight information, in order to improve the visual effects. Conventionally, the local dimming controller may first complete the calculation of a frame of backlight data, and then adjust respective backlight data sequentially by using specific backlight control algorithms. The algorithms may realize several desired visual effects such as temporal filtering, spatial filtering, suppressing and diffusing. The temporal filtering may slow down the speed of lighting or dimming on a specific point, which may be achieved by comparing the backlight data between consecutive image frames. The spatial filtering may smooth the image in an area, to avoid a sharp brightness change observed by the user. The suppressing or diffusing may decrease or increase the brightness of a specific backlight unit with reference to the diffuse lights of adjacent backlight units.

In the present invention, the backlight calculation is performed in a pipelined manner, where the backlight data of the first row of backlight units may be calculated and adjusted when the image data corresponding to the second row of backlight units are being received. In such a situation, since the backlight data of the second row of backlight units have not been calculated, the adjustment of the backlight data of the first row may be performed by referring to the previous backlight data in the second row of backlight units. In addition, the algorithms should be well designed to prevent the adjustment of backlight data and the parallel calculations of adjacent backlight data from being affected by each other.

Note that the present invention aims at providing a novel method of handling the backlight of a display panel. Those skilled in the art may make modifications and alterations accordingly. For example, in the above embodiments, the local dimming controller and image processing circuit are used for vehicle display applications. The conventional vehicle display devices have the problems that the backlight data have a 1-frame delay and the backlight output is not synchronous to the image data output, causing that the accuracy of images decreases which affects the driving safety. Therefore, the present invention provides a pipelined and parallel processing method for local dimming control to timely calculate and output the backlight data, so as to improve the display accuracy. In other embodiments, the present invention may not be limited to vehicle display applications. In fact, as long as a display system performs displaying with a non-self-luminous panel such as an LCD panel, the local dimming control method of the present invention should be applicable.

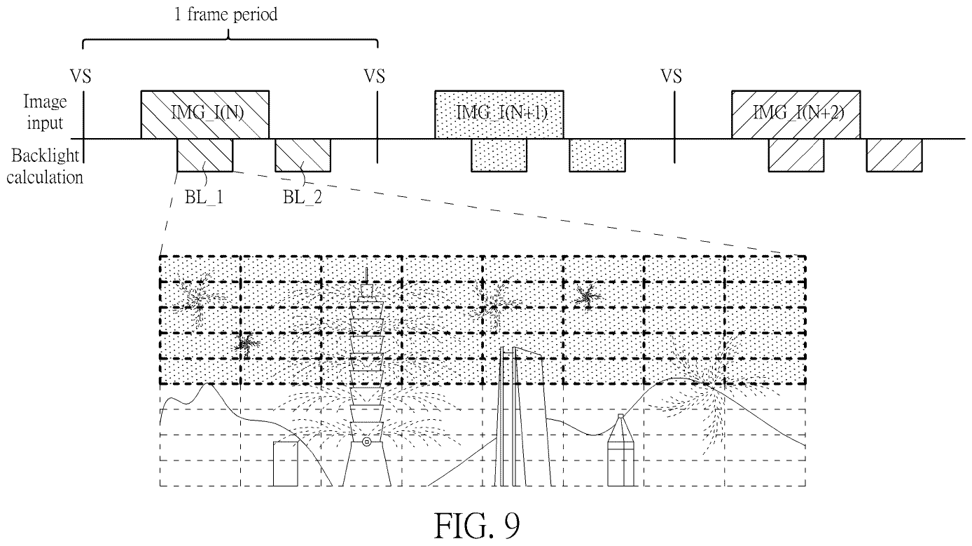

In the embodiments of the present invention, the image data may be partitioned in various manners. For example, a frame of image data may be divided into any number of partitions to perform backlight calculation and image compensation. Each part may have the same or different sizes, and may be arranged in any appropriate manner according to system requirements. For example, in another embodiment, a frame of input image data (e.g., IMG_I (N) ) is divided into only 2 parts, an upper part and a lower part, as shown in FIG. 9. When the upper part is completely received, the backlight calculation is performed to generate the backlight data BL_1 for the upper part. At this time, the local dimming controller is still receiving the image data of the lower part. Subsequently, when the lower part is completely received, the backlight calculation is performed to generate the backlight data BL_2 for the lower part.

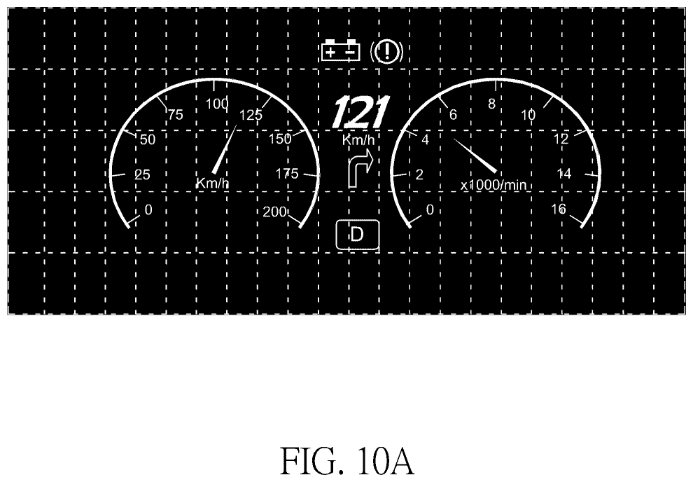

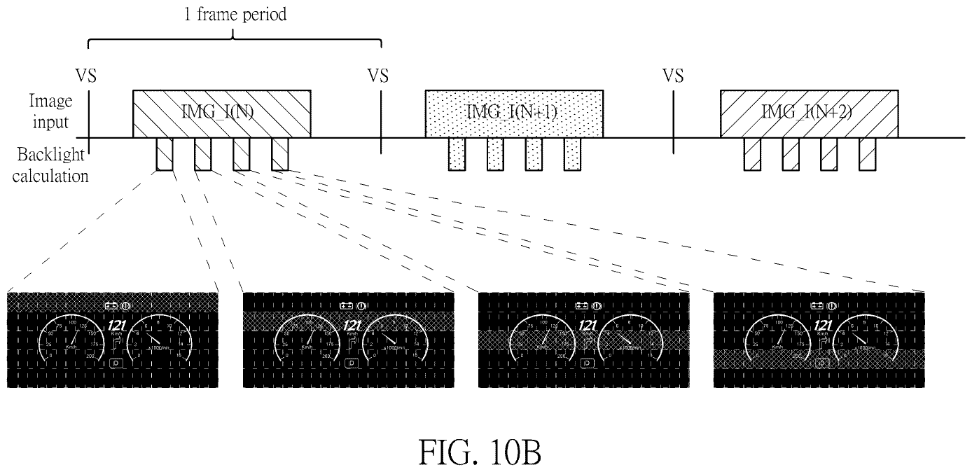

Based on the operations of pipelined backlight calculation and image compensation with partitioned image data in a frame, more applications may be realized. In an embodiment, if the local dimming controller determines that the backlight data for one or more specific parts of an image frame do not need to be updated, the backlight data calculation circuit may stop calculating these backlight data. For example, FIG. 10A illustrates a frame of image to be sent to the dashboard of a car, where an array of backlight units is represented by multiple grids covered on the image. Note that the partition of the image data is based on the arrangements of backlight units to achieve parallel backlight calculation. As shown in FIG. 10A, the image corresponding to the bottom row of backlight units is completely black; hence, there should be always no backlight in this area, which means that the corresponding backlight data indicate no light emission. With backlight calculation in partitions, the backlight calculation for this black area may be omitted, in order to reduce the backlight calculation time and save power.

FIG. 10B illustrates a detailed implementation of the pipelined backlight processing for the image frame shown in FIG. 10A. In this embodiment, the frame of input image data IMG_I (N) may be divided into 5 parts, where each part corresponds to several rows of backlight units. The local dimming controller may know that the images in the last part are all black images in advance, and thus it only performs backlight calculation for the 1^{st} to the 4^{th} parts of image data and correspondingly outputs the backlight data BL_1-BL_4, while stops the backlight calculation for the last part of image data.

Note that the conventional local dimming operation calculates the backlight of the entire frame as a whole, and then outputs the backlight data to the backlight driver after the entire frame of backlight data is completely obtained. Therefore, it is not possible to omit the calculation of partial backlight data. In comparison, since the image data are partitioned to perform backlight calculation according to the present invention, the backlight data could only be calculated for partial image data under some scenarios. As a result, the overall computation and operation time for backlight calculation may be reduced, thereby decreasing the costs and power consumption.

In an embodiment, the local dimming controller may further predict the content of the image, and calculate the backlight data corresponding to the predicted image data before receiving the image data. In this manner, the backlight calculation may be performed and the backlight data may be sent to the backlight driver timelier.

The method of calculating backlight based on the predicted image data may be applicable to a non-vehicle display. As mentioned above, the vehicle display system has requirements of high accuracy, and thus it is not preferable to use predicted images to perform backlight calculation. In the non-vehicle display, if it is possible to analyze and predict partial image data that have not been received, the local dimming controller may use the pipelined approach to calculate and send the backlight data earlier based on the predicted image data, allowing the backlight output to be more synchronous and in time.

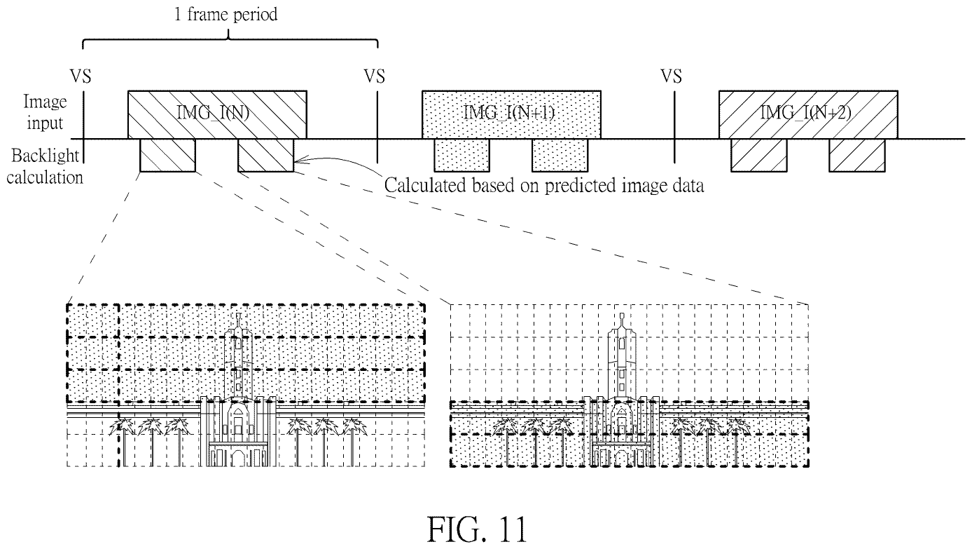

FIG. 11 illustrates a detailed implementation of performing backlight calculation based on predicted image data. In this embodiment, it is assumed that a frame of input image data IMG_I (N) is divided into two parts. When the upper part is completely received, the backlight data calculation circuit may start to perform backlight calculation on the upper part. At this time, although the lower part has not been received, the local dimming controller may predict the image content of the lower part based on an image predicting algorithm. Therefore, the backlight data calculation circuit may calculate the backlight data for the lower part based on the predicted image data of the lower part. Note that the images in the lower part may be similar to the corresponding images in the previous frame and related to the upper part to some extent, which makes the images predictable.

Alternatively, if the local dimming controller predicts that one or several parts of the image frame keep unchanged for one or several frame periods, the backlight calculation of the part(s) may also be omitted. In such a situation, the backlight driver may use the previously calculated backlight data to generate backlight emissions for the part(s) of the image frame, so as to reduce the processing time and power consumption of backlight calculations.

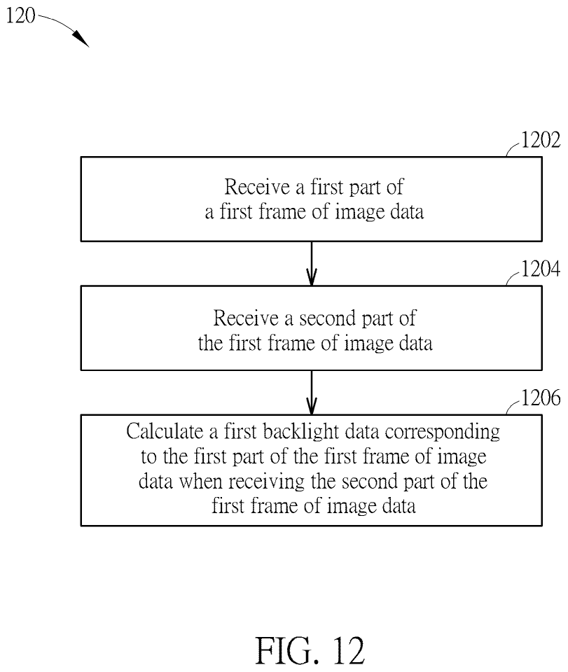

The abovementioned implementations and operations of the local dimming controller may be summarized into an image processing process 120, as shown in FIG. 12. The image processing process 120 may be implemented in a local dimming controller such as the local dimming controller 200 shown in FIG. 2, which may be operated as or included in the image processing circuit 108 shown in FIG. 1. As shown in FIG. 12, the image processing process 120 includes the following steps:
Step 1202: Receive a first part of a first frame of image data.
Step 1204: Receive a second part of the first frame of image data.
Step 1206: Calculate a first backlight data corresponding to the first part of the first frame of image data when receiving the second part of the first frame of image data.

The detailed operations and alterations of the image processing process 120 are described in the above paragraphs, and will not be repeated herein.

To sum up, the present invention provides a method of handling backlight of a display panel, where the backlight calculation and image data compensation and output could be performed in the same frame period; hence, the image data and backlight data may be output synchronously without significant delay. In addition, the backlight data may be calculated and output in a pipelined manner, to achieve the benefit of utilizing the longer active interval to deliver the backlight data. In other words, the backlight output is not limited to be within the blanking interval. This significantly improves the output capability of the backlight data, which is beneficial to local dimming applications for large-scale panels. In one or some embodiments, if the local dimming controller determines that the backlight data for one or more specific parts of an image frame do not need to be updated, the calculations of these backlight data may be omitted, to further reduce the processing time and power consumption of backlight calculations. In one or some embodiments, if the local dimming controller could predict the image data in one or more specific parts of an image frame before these image data are received, the backlight calculations may be performed based on the predicted image data, allowing the backlight output to be more synchronous.

Those skilled in the art will readily observe that numerous modifications and alterations of the device and method may be made while retaining the teachings of the invention. Accordingly, the above disclosure should be construed as limited only by the metes and bounds of the appended claims.

1. A method of handling a backlight of a display panel, comprising:
receiving a first part of a first frame of image data;
receiving a second part of the first frame of image data; and
calculating a first backlight data corresponding to the first part of the first frame of image data during the reception of the second part of the first frame of image data.

2. The method of claim 1, wherein the first part and the second part of the first frame of image data are received in an active interval of a frame period, and the first backlight data is calculated in the active interval.

3. The method of claim 2, further comprising:
outputting the first backlight data to a backlight driver in the active interval.

4. The method of claim 2, further comprising:
outputting the first frame of image data and the first backlight data in the frame period.

5. The method of claim 1, further comprising:
outputting the first backlight data before calculating a second backlight data corresponding to the second part of the first frame of image data.

6. The method of claim 1, wherein the first frame of image data is received and output without being written into a frame buffer.

7. The method of claim 1, further comprising:
calculating a compensation data corresponding to the first part of the first frame of image data according to the first backlight data when receiving the second part or a third part of the first frame of image data.

8. The method of claim 7, further comprising:
compensating the first part of the first frame of image data by using the compensation data; and
outputting the compensated first part of the first frame of image data to a display driver.

9. The method of claim 1, wherein the first frame of image data further comprises a third part, and the method further comprises:
stopping calculating a third backlight data corresponding to the third part of the first frame of image data when determining that the third backlight data does not need to be updated.

10. The method of claim 1, wherein the first frame of image data further comprises a fourth part, and the method further comprises:
predicting the fourth part of the first frame of image data; and
calculating a fourth backlight data corresponding to the predicted fourth part of the first frame of image data before receiving the fourth part of the first frame of image data.

11. An image processing circuit to handle a backlight of a display panel, the image processing circuit being to:
receive a first part of a first frame of image data; and
receive a second part of the first frame of image data; and
the image processing circuit comprising:
a backlight data calculation circuit to calculate a first backlight data corresponding to the first part of the first frame of image data during the reception of the second part of the first frame of image data by the image processing circuit.

12. The image processing circuit of claim 11, wherein the image processing circuit receives the first part and the second part of the first frame of image data in an active interval of a frame period, and the backlight data calculation circuit calculates the first backlight data in the active interval.

13. The image processing circuit of claim 12, wherein the backlight data calculation circuit further outputs the first backlight data to a backlight driver in the active interval.

14. The image processing circuit of claim 12, further comprising an image compensation circuit, wherein the image compensation circuit outputs the first frame of image data and the backlight data calculation circuit outputs the first backlight data in the frame period.

15. The image processing circuit of claim 11, wherein the backlight data calculation circuit further outputs the first backlight data before calculating a second backlight data corresponding to the second part of the first frame of image data.

16. The image processing circuit of claim 11, wherein the image processing circuit receives and outputs the first frame of image data without writing the first frame of image data into a frame buffer.

17. The image processing circuit of claim 11, further comprising:
an image compensation circuit to calculate a compensation data corresponding to the first part of the first frame of image data according to the first backlight data when the image processing circuit is receiving the second part or a third part of the first frame of image data.

18. The image processing circuit of claim 17, wherein the image compensation circuit is further to:
compensate the first part of the first frame of image data by using the compensation data; and
output the compensated first part of the first frame of image data to a display driver.

19. The image processing circuit of claim 11, wherein the first frame of image data further comprises a third part, and the backlight data calculation circuit stops calculating a third backlight data corresponding to the third part of the first frame of image data when determining that the third backlight data does not need to be updated.

20. The image processing circuit of claim 11, wherein the first frame of image data further comprises a fourth part, and the image processing circuit predicts the fourth part of the first frame of image data, and the backlight data calculation circuit calculates a fourth backlight data corresponding to the predicted fourth part of the first frame of image data before the image processing circuit receives the fourth part of the first frame of image data.

21. A display system comprising:
a display panel;
a display driver, coupled to the display panel;
a backlight driver, coupled to a backlight module of the display panel; and
an image processing circuit, coupled to the display driver and the backlight driver, to handle a backlight of the display panel, the image processing circuit being to receive a first part of a first frame of image data and receive a second part of the first frame of image data, and comprising:
a backlight data calculation circuit to calculate a first backlight data corresponding to the first part of the first frame of image data during the reception of the second part of the first frame of image data by the image processing circuit.

22. The display system of claim 21, wherein the image processing circuit receives the first part and the second part of the first frame of image data in an active interval of a frame period, and the backlight data calculation circuit calculates the first backlight data in the active interval.

23. The display system of claim 22, wherein the backlight data calculation circuit further outputs the first backlight data to the backlight driver in the active interval.

24. The display system of claim 22, wherein the image processing circuit further comprises an image compensation circuit, wherein the image compensation circuit outputs the first frame of image data and the backlight data calculation circuit outputs the first backlight data in the frame period.

25. The display system of claim 21, wherein the backlight data calculation circuit further outputs the first backlight data before calculating a second backlight data corresponding to the second part of the first frame of image data.

26. The display system of claim 21, wherein the image processing circuit receives and outputs the first frame of image data without writing the first frame of image data into a frame buffer.

27. The display system of claim 21, wherein the image processing circuit further comprises:
an image compensation circuit to calculate a compensation data corresponding to the first part of the first frame of image data according to the first backlight data when the image processing circuit is receiving the second part or a third part of the first frame of image data.

28. The display system of claim 27, wherein the image compensation circuit is further to:
compensate the first part of the first frame of image data by using the compensation data; and
output the compensated first part of the first frame of image data to the display driver.

29. The display system of claim 21, wherein the first frame of image data further comprises a third part, and the backlight data calculation circuit stops calculating a third backlight data corresponding to the third part of the first frame of image data when determining that the third backlight data does not need to be updated.

30. The display system of claim 21, wherein the first frame of image data further comprises a fourth part, and the image processing circuit predicts the fourth part of the first frame of image data, and the backlight data calculation circuit calculates a fourth backlight data corresponding to the predicted fourth part of the first frame of image data before the image processing circuit receives the fourth part of the first frame of image data.
